(19) United States
(12) Patent Application Publication
(10) Pub. No.: US 2008/0252248 A1
(43) Pub. Date: Oct. 16, 2008

(54) Device and Method for Calibrating the Center Point of a Tool Mounted on a Robot by Means of a Camera

(75) Inventors: Ivan Lundberg, Vasteras (SE); Niklas Durinder, Vasteras (SE); Torgny Brogardh, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 11/883,127

(22) PCT Filed: Jan. 24, 2006
(86) PCT No.: PCT/EP2006/050381

§ 371 Date: Jul. 26, 2007

(30) Foreign Application Priority Data
Jan. 26, 2005 (SE) 0500217-5

(51) Int. Cl. B25J 9/16

(52) U.S. Cl. 318/572; 901/47

(57) ABSTRACT

A device and a method for tool center point calibration of an industrial robot. The device is intended to calibrate an industrial robot with respect to a tool mounted on the robot. The device includes a camera designed to take a plurality of images of at least part of the robot tool for a plurality of different tool orientations, an image-processing unit designed to determine the positions of the robot tool in the orientations based on the images, a calculation module adapted to calculate the position of the center point of the robot tool, based on the determined positions, and a control module adapted to calculate the corrective movements of the robot.

### TECHNICAL FIELD

The present invention relates to a device and a method for tool centre point calibration, hereinafter referred to as TCP calibration, of an industrial robot. The device is intended to calibrate an industrial robot with respect to a tool mounted on the robot

### BACKGROUND ART

Carrying out accurate measurement of the centre point of a tool mounted on an industrial robot is of the utmost importance for the robot to be able to perform its programmed work tasks correctly. The methods applied today for TCP calibration are both impractical and slow. This particularly applies to the case where it is necessary to use an operator for carrying out the calibration. An industrial robot usually has 4-6 axes of rotation. The last link in the chain may consist of a toolholder. Different tools are used depending on the field of application and may be, for example, a gripper, a glue gun or a welding tool. The position for this tool relative to the base coordinate system of the robot is measured or calibrated before use after, for example, installation, tool change, replacement of part of the tool, collision, wear, and service. TCP (Tool Centre Point) means the position that the tool operated by the robot is to have relative to the base coordinate system of the robot to ensure that the tool has the correct position relative to the work object. It is known to carry out such calibration with the aid of light beams, for example light-emitting diodes, laser, or IR. The light beams are used to determine the position of the tool relative to the robot. The position of the tool is determined for a plurality of tool orientations and the tool centre point (TCP) is determined based on the determined tool positions.

U.S. Pat. No. 5,457,367-A, for example, shows a method for TCP calibration for a tool mounted on a robot with a calibration unit comprising a light emission unit that illuminates a predetermined point on the tool in different tool positions, whereupon the real position of the tool is calculated with the aid of measured position indications, and the tool is thereafter positioned by the robot to the correct position.

Another technique is described in SE 508161, in which a spherical calibration tool with a known radius is illuminated by a calibration beam. When an interruption in the calibration beam is detected, the output signals from the position transducers of the robot axes are read and stored. This method is repeated a plurality of times with different configurations of the robot. Then the calibration parameters of the robot are calculated on the basis of the kinematic equations of the robot, the read and stored position transducer signals, and the known radius.

A further technique is described in U.S. Pat. No. 6,356,808-B1, wherein a light emission unit is mounted close to the working range of the robot. In this solution, it is not necessary to know where the light emission unit is in relation to the robot, and in addition it is not necessary to know the direction of the emitted light beam. On the other hand, it shall be possible to discover when the light beam is broken.

The disadvantage of using the above-mentioned solutions is that it takes a relatively long time (5-10 minutes) to use light beams to carry out each calibration. The reason for the relatively large time expenditure is that the tool must break the light beam a plurality of times to have its con-tour determined. Each time the tool breaks the beam, a point on the contour of the tool is obtained, and when a sufficient number of points have been measured, the position of the tool may be determined relative to the base coordinate system of the robot. It is also known to carry out TCP calibration by manually performing measurement at at least four points on the tool, but also this method is unpractical and slow.

An additional method for carrying out TCP calibration is to use a CMM (Coordinate Measuring Machine), which provides very high precision of the measurement. The disadvantage of this method is that it is expensive and slow. In addition, the accuracy obtained using this type of measurement is, in many cases, unnecessarily high.

### SUMMARY OF THE INVENTION

It is an object of the invention to provide a device and a method for TCP calibration, which do not exhibit the disadvantages described above.

This object is achieved with the initially described device which is characterized in that the device comprises:
a camera designed to take a plurality of images of at least part of the robot tool for a plurality of different tool orientations,
an image-processing unit designed to determine the positions of the robot tool in said orientations based on said images,
a calculation module adapted to calculate the position of the centre point of the robot tool, based on said determined positions, and
a control module adapted to calculate the corrective movements of the robot.

Corrective movement in this case means the movement that the robot must carry out to return the TCP to its original position. How large this corrective movement is depends on how much the TCP has been moved when the tool has been reoriented.

The advantage achieved by using a camera is that all positions along the contour of the tool are obtained on one and the same measurement occasion. Measurement using a camera means that the position of the tool is obtained in the system of coordinates of the camera. The position of the camera in relation to the system of coordinates of the robot is not known. One advantage achieved is that a faster calibration of the tool may be performed. Another advantage is that a higher repetition accuracy and better precision are obtained, which leads to higher operating availability of the robot.

One further advantage achieved is that reorientation about the axis of the camera lens and the axis of the tool means that the shape of the tool is not changed, which makes it easier for the image-processing unit to locate the TCP in a simple manner.

Still another advantage achieved is that it is considerably less expensive to use a camera for determining position compared with using, for example, laser or IR.

Yet another advantage achieved is that it is possible to carry out the calibration without an operator having to be involved in the work.

According to one embodiment of the invention, the camera is arranged within the working range of the robot. This means that the camera, during the period of the calibration, is fixed at a definite point within the working range of the robot and is thus not movable at that time.

According to another embodiment of the invention, the device comprises a light source arranged such that the location of the tool is between the light source and the camera. The advantage obtained by this is that also tools that emit reflexes, which normally entails problems since these may fool the image-processing unit, may be determined, in a simple manner, with respect to their position with the aid of the image-processing unit.

### BRIEF DESCRIPTION OF THE DRAWINGS

The invention will now be explained in greater detail, by description of various embodiments, with reference to the accompanying drawings.

FIG. 1 shows a tool mounted on a robot in a robot cell with a device according to one embodiment of the invention.

FIG. 2 shows the tool in different positions during the calibration procedure with respect to the position in relation to a plane.

FIG. 3 shows the tool in different positions during the calibration procedure with respect to the position in the horizontal and vertical directions.

### DETAILED DESCRIPTION OF DIFFERENT EMBODIMENTS OF THE INVENTION

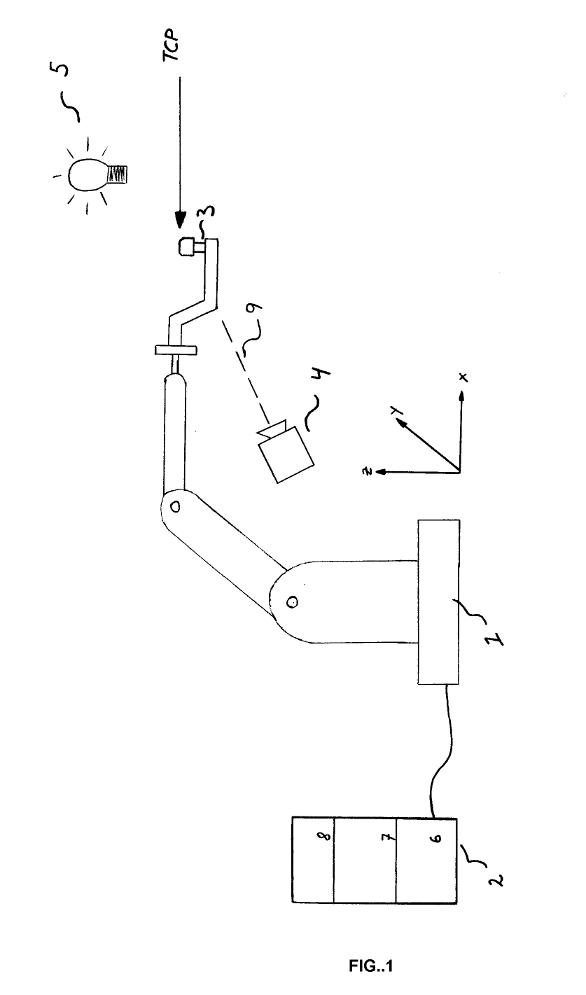

FIG. 1 shows a robot cell comprising a robot 1 with a control unit 2 connected thereto and a tool 3 connected to the robot. The control unit 2 comprises, inter alia, at least one processor and at least one memory unit. The control unit 2 stores the control program of the robot and an algorithm that controls the TCP calibration. The control unit 2 also stores the position of the desired TCP as well as geometrical information about the tool 3 in different predetermined positions. Accommodated in the control unit 2 is an image-processing unit 6 containing an image-processing algorithm. The image-processing algorithm may be any image-processing algorithm that is useful according to the state of the art. Furthermore, the control unit 2 comprises a calculation module 7 containing an algorithm intended to calculate the TCP, and the control unit also comprises a control module 8 adapted to calculate the corrective movements of the robot. According to the invention, a camera 4 is arranged within the working range of the robot 1. The camera 4 is arranged so as to take photos of the tool 3 when the robot 1 is in the calibration position. In the control unit 2, a control program is stored. This control program is intended to control the whole calibration procedure and includes a procedure that causes the camera 4 during the calibration procedure to automatically capture images of the tool in its different positions. The control program may be any control program that is useful according to the state of the art.

In addition, the invention comprises a light source 5 which is arranged so that the tool 3 is located between the light source 5 and the camera 4. The light source 5 is arranged for the purpose of improving the contrasting effect for the illuminated tool 3, allowing the images captured by the camera 4 to be analyzed in the best way later on with the aid of the image-processing unit 6.

The images captured by the camera 4 are preferably digital ones. The tools are preferably rotationally symmetrical.

When the tool 3 is to be TCP-calibrated, this occurs by the camera 4 taking a series of images of the tool 3 in at least three different positions. This is done by the robot 1 reorienting the tool 3 to at least three different pre-determined positions, the positional data of which are stored in the control unit 2.

The predetermined tool positions are determined in the same way as described in the prior art.

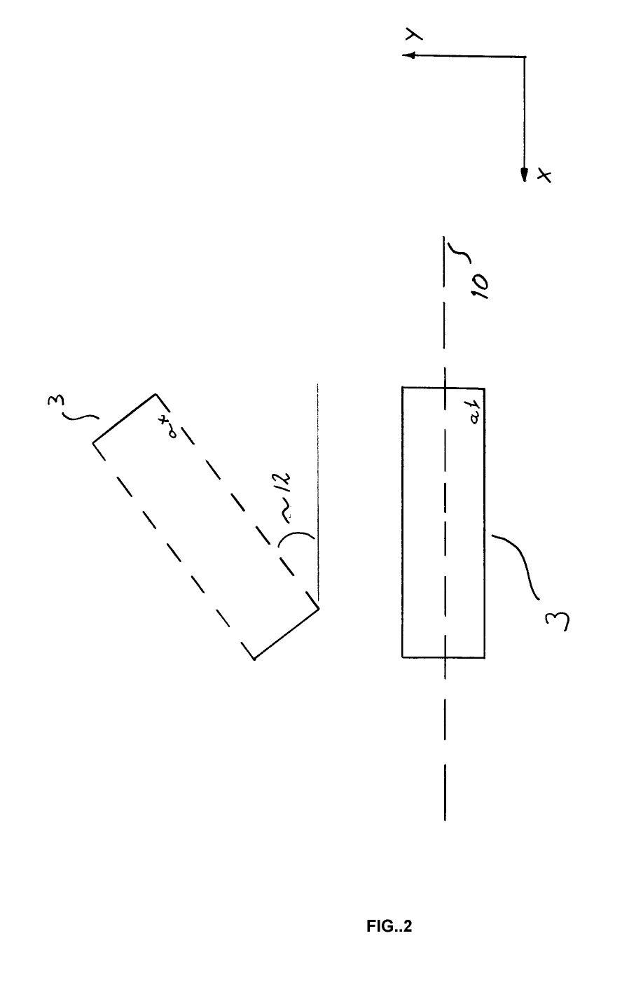

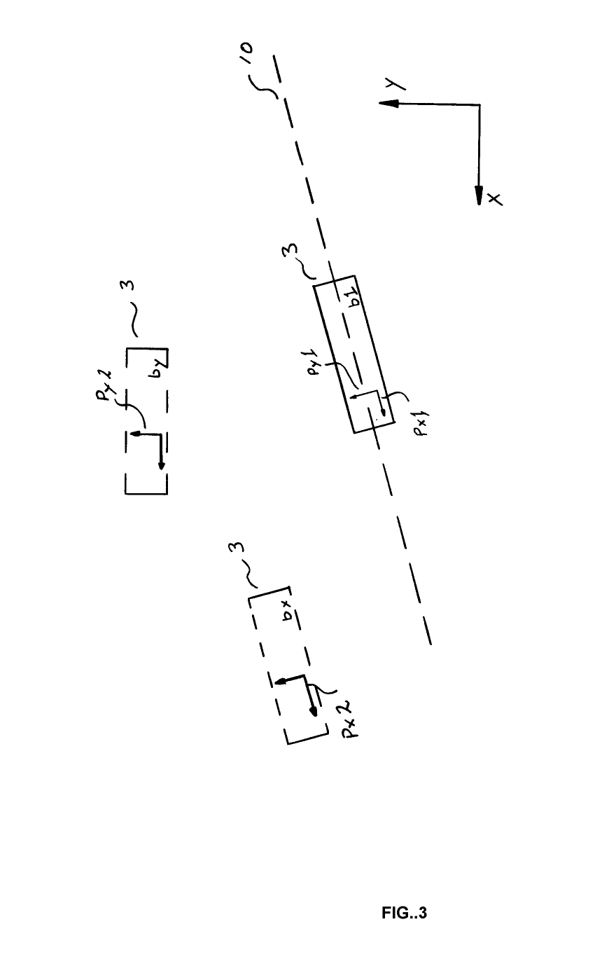

FIG. 2 and FIG. 3 show how the system of coordinates of the camera 4 is calibrated such that the orientation of the system of coordinates of the camera is known in relation to the base coordinate system of the robot 1, in that the camera 4 takes a first image (b1) of the tool 3 in the first position. Then, the robot 1 translates the tool 3 in the horizontal direction (x-direction) to a new position at least once. After each translation, the camera 4 takes a new image (bx) of the tool 3. The image-processing unit 6 is then used to compare the images (b1 and bx) in order thus to assess when the tool 3 has the same size in the respective image, which means that a correct position in the x-direction has been identified. In the same way as described above, also the position in the vertical direction (y-direction) is then determined, with the difference that the images (b1) and (by) are then compared. When the size of the tool 3 is the same in three images (b1, bx and by), the calculation module 7 is used for calculating the plane of the camera 4 and how this plane is oriented relative to the system of coordinates of the robot 1. The orientation of the plane is given by the position of the robot 1 in the three images. Then, the camera 4 is fixed in the working range of the robot so that it cannot change its position during the calibration procedure.

To ensure that the TCP is in the correct plane, that is, that plane that is orthogonal compared with the lens of the camera 4, the camera 4 captures a first image of the tool 3 when the tool is in the first position (a1). Then the robot 1 reorients the tool 3 around the projected axis of rotation 10 of the tool to a new position (ax), whereupon the camera 4 captures a new image of the tool 3. Thereafter, the image-processing unit 6 and the control module 8 are utilized to measure and calculate the angle 12. The calculation module 7 is then used to calculate how the robot 1 should correct the orientation of the tool 3 in order for the tool 3 to be correctly positioned in the plane, which means that the rotationally symmetrical line 10 of the tool should lie in the plane. To ensure that the TCP is situated in the plane, the method described above is then repeated a number of times until the TCP lies in the plane.

To find the correct TCP in the horizontal plane (x), which is the plane that is orthogonal to the symmetry line 9 of the camera lens, the camera 4 then captures a first image of the tool 3, whereupon the current TCP (Px1) is determined using the image-processing unit 6. After this, the robot 1 reorients the tool 3 to a new position by rotating the tool 3 around the symmetry line 9 of the camera lens, whereby the camera 4 captures a new image of the tool and the current TCP (Px2) is determined by means of the image-processing unit 6. Thereafter, the difference in position between Px1 and Px2 is calculated by means of the calculation module 7 included in the control unit 2. Then, the robot 1 translates the tool 3 such that Px2 comes as close to Px1 as possible. To find the correct TCP, the method described above is then repeated a number of times until the difference (measured in the number of pixels in the images captured by the camera 4) between Px1 and Px2 lies within the margin of error stated. The value of the coordinates of the TCP in the plane (x, y) is calculated based on the position of the robot in Px1 and Px2 as well as the known angle of the reorientation in the plane.

To find the correct TCP in the vertical plane (y), the camera 4 then captures a first image of the tool 3, whereupon the current TCP (Py1) is determined by means of the image-processing unit 6. Then, the robot 1 reorients the tool 3 to a new position by rotating the tool 3 around its own axis of rotation 10, whereby the camera 4 captures a new image (By) of the tool and the current TCP (Py2) is determined by means of the image-processing unit 6. Thereafter, the difference in position between Py1 and Py2 is calculated by means of the calculation module 7 included in the control unit 2. Then, the robot 1 translates the tool 3 such that Py2 comes as close to Py1 as possible. To find the correct TCP, the method described above is then repeated a number of times until the difference (measured in the number of pixels in the images captured by the camera 4) between Py1 and Py2 lies within the margin of error stated. The value of the coordinate of the TCP orthogonally to the plane (z) is calculated based on the position of the robot in Py1 and Py2 as well as the known angle of the reorientation about the symmetry line of the tool.

For tools with a complex geometry, determining the TCP may entail problems, and in that case TCP calibration may be carried out with the aid of a manually operated pointer tool. The measuring point on this tool has a well-defined geometry which the image-processing system recognizes in the image captured by the camera 4.

According to an alternative embodiment of the invention, an operator is able to manually control the calibration procedure including the photographing of the tool 3 in its different positions.

According to another alternative embodiment of the invention, the camera 4 is stationarily located within the working range of the robot 1.

According to a further alternative embodiment of the invention, a plurality of cameras are located within the working range of the robot 1.

According to a yet another alternative embodiment of the invention, an operator is able to manually control the calibration procedure including the photographing of the tool 3 in its different positions.

The invention is not limited to the embodiments shown but may be varied and modified within the scope of the following claims. For example, the processor and the control unit 2 that are housed in the control unit may be replaced by an external computer, for example a pc or a PDA (Personal Digital Assistant).

1. A device for tool center point calibration of a robot with a tool mounted on the robot, the device comprising:
a camera designed to capture a plurality of images of at least part of the robot tool for a plurality of different tool orientations,
an image-processing unit designed to determine the positions of the robot tool in said orientations based on said images,
a calculation module adapted to calculate the position of the center point of the robot tool, hereinafter referred to as the tool center point, based on said determined positions, and
a control module adapted to calculate the corrective movements of the robot.

2. The device according to claim 1, wherein the camera is arranged within the working range of the robot.

3. The device according to claim 2, further comprising:
a light source which is arranged so that the tool is placed between the light source and the camera.

4. A method for tool center point calibration of a robot with a tool mounted on the robot, the method comprising:
capturing a first image of the tool in a first-orientation,
reorienting the tool to new orientations, whereby images of the tool are captured in the new orientations,
determining the positions of the tool in said orientations based on said images, and
calculating the tool center point based on said determined positions and updating the tool center point of the robot based on the calculated tool center point.

5. The method according to claim 4, wherein the camera is arranged within the working range of the robot.

6. The method according to claim 4, wherein the tool is illuminated by a light source from a direction opposite to the direction from which the images are captured, to obtain the best possible contrasting effect.
